(19) United States
(12) Patent Application Publication
(10) Pub. No.: US 2009/0251601 A1
(43) Pub. Date: Oct. 8, 2009

(54) Method and device for synchronizing camera systems

(75) Inventors: Joachim Ihlefeld, Dresden (DE); Carsten Kunze, Dresden (DE); Thomas Oelschlaeger, Dresden (DE); Frank Raedisch, Rothenburg (DE); Dietmar Scharf, Pirna (DE); Oliver Vietze, Frauenfeld (CH)

Correspondence Address: DeMont & Breyer, LLC, 100 Commons Way, Ste. 250, Holmdel, NJ, 07733, US

(73) Assignee: BAUMER OPTRONIC GMBH, Radeberg (DE)

(21) Appl. No.: 12/417,866

(22) Filed: Apr. 3, 2009

(30) Foreign Application Priority Data
Apr. 8, 2008 (DE) 10 2008 017 933.7

(51) Int. Cl. H04N 5/06; H04L 5/14

(52) U.S. Cl. 348/521; 370/276; 348/E05.011

(57) ABSTRACT

The invention relates to a method and to a device for synchronizing the image capture by cameras. For this purpose, a duplex-capable network is provided. Within the network, one or more hardware-supported synchronization modules with a logical channel of a first type are provided, wherein the synchronization module or modules transmit, via the logical channel, image-capture signals that control the capture time of image sensors, wherein the image-capture signals are received by image-capture devices, and wherein the image-capture devices each capture an image as a response to the reception of an image-capture signal, and wherein the image data is then transmitted via the network by the image-capture devices via a logical channel of a second type.

### FIELD OF INVENTION

The present invention relates to the field of automatic image processing in general and, more particularly, to synchronizing camera systems.

### BACKGROUND OF THE INVENTION

For automatic image processing, the networking of cameras, peripheral sensors, and computers into complex systems is playing an increasingly important role. Communications are performed via standardized networks, the most well-known of which are Firewire IEEE 1394 and Ethernet IEEE802.3. For connecting cameras, other standards are available, the most well-known are of which DCAM and the GigE-Vision™ standard published by AIA (Automated Imaging Association).

In addition to providing high bandwidth for the transmission of images, precise time synchronization of cameras, lighting units, and other sensors is a basic prerequisite for high performance.

In EP1793574, a communications method that can be used in the field of telecommunications is described as an example in which, by means of a trigger server, an external signal is transmitted in a network by means of a broadcast call to a defined subscriber circuit, this signal is acknowledged by this subscriber circuit, and then connections are set up. The described method is unsuitable, however, for fast response times.

For industrial controllers, synchronization methods for networks have been described that use local real-time clocks (RTC) synchronized with each other in connection with the IEEE1588 standard, as is the case, e.g., in EP1484869 and EP1860520. During operation, the trigger signal is transmitted to the nodes with a sufficiently high lead time and with information concerning the desired trigger time. This method requires a sufficient number of RTCs in the system and the use of suitably fast protocols.

For systems with especially strict time requirements, solutions have been described that achieve particularly low jitter in time-relevant information, e.g., EP1702245, through special precautions—e.g., a cache controller—for a continuous transmission of data packets without gaps in a fixed data format. The data packets transmitted with time precision are then evaluated with hardware on the receiver side. The disadvantage of these solutions is the low flexibility, because one transmission channel is constantly busy.

From EP 1 554 839, a system design is further known that exchanges data in a real-time and a non-real-time mode and that calculates and adapts the time distribution of the two operating modes in real time. This, however, requires a previously known behavior of the bus subscribers.

### SUMMARY OF THE INVENTION

The problem of the invention consists in proposing, for the synchronization of image-processing systems in networks, a suitable architecture that avoids the mentioned disadvantages and that allows both a fast response to trigger events and also an optimized transmission of large data volumes of unknown length.

This problem is solved by the subject matter of the independent claims. Advantageous implementations and refinements of the invention are specified in the corresponding dependent claims.

The problem of the invention is solved in that two duplex-capable channels are provided in parallel to the devices specified in the network for image-processing tasks:
a logical control channel optimized for short response times for short telegrams
a logical data channel optimized for high data throughput
   wherein the control channel is implemented as a proxy and is controlled in real time by hardware, and the data channel uses constant or variable formats that have been optimized for data throughput, e.g., Jumbo frames.

Image-processing systems require, as a rule, relatively short, time-precise control information, e.g., the start pulse for an image (trigger for the beginning of the exposure time) that also activates the lighting parallel in time for the use of pulsed lighting devices. Here it is important that, especially for multi-camera systems, the trigger is transmitted within a defined time tolerance. The exact tolerances depend on the application to be realized. As a rule, the time jitter between the trigger signals of the cameras and lighting devices with respect to each other is more critical than a uniform offset for all of the signals, e.g., the common start signal of an SPS. In this way, an especially favorable architecture is produced when the synchronization module transmits a broadcast signal locally, e.g., by means of a switch, to the devices belonging to a group, wherein each device evaluates this signal with hardware under the same time conditions. The time tolerance includes an offset that is approximately equal for all of the devices and that can be processed with typical image-processing algorithms.

In larger networks, it is useful to monitor the delay time between synchronization modules and cameras since it can deviate during operation. For this purpose, the typical delays and their variance are calculated, stored, and then evaluated by means of error and exception handling.

The other processes, including data transmission from an image memory or—if necessary—turning off the lighting, are triggered by internal state machines and therefore, as a rule, do not require additional signals.

The data quantity to be transmitted is dependent on the selected operating modes of the camera and also on the image contents for the use of image-preprocessing units. This information is not known a priori to the control computer (host). Therefore, as a rule, it is not possible to plan and then to control with time precision the transmission of the cameras from a host. For this reason, it is favorable to allow a defined break in a transmission with the option to discard the remaining non-transmitted data or to transmit it from the image memory at a later time.

According to the preceding description, in general, the invention provides a method for synchronizing camera systems or for synchronizing the image capture by cameras by means of a duplex-capable network in which, within the network, one or more hardware-supported synchronization modules with a logical channel of a first type are used, wherein the synchronization module or modules transmit image-capture signals, especially in the form of trigger telegrams, via the logical channel. The trigger telegrams here control the capture time for image sensors and are received by the image-capture devices connected to the network. In response to the reception of an image-capture signal, the image-capture devices then each capture at least one image. The image data is then transmitted by the image-capture devices via a logical channel of a second type via the network in order to be able to further process this data.

A networked camera system with several image-capture devices is also provided accordingly for executing the method according to the invention. The camera system has a duplex-capable network, one or more hardware-supported synchronization modules connected to the duplex-capable network with a logical channel of a first type, wherein the synchronization module or modules are designed to transmit image-capture signals that control the image-capture time of image sensors of the image-capture devices via the logical channel of the first type, wherein the image-capture signals are received by the image-capture devices, and wherein the image-capture devices capture an image as a response to the reception of an image-capture signal, and wherein the image-capture devices are designed to then transmit captured image data via a logical channel of a second type via the network.

External switching signals can each be received or transmitted by means of one or more trigger inputs or outputs of the synchronization module or modules. Switching signals output by the synchronization module can be used for triggering a camera and also for triggering a flash or, in general, a lighting device. The synchronized capture realized according to the invention with several cameras is especially advantageous in connection with lighting by one or more flashes triggered by external switching signals, because, in this way, less jitter in the propagation times via the network or, in general, minimal time differences between the captures of different cameras can be equalized.

Likewise, a trigger signal can be input to a trigger input of a synchronization module, whereupon the synchronization module transmits, in response to this trigger signal, at least one image-capture signal via the network. Both the trigger inputs named above and also the trigger outputs can be, in particular, external or additional terminals that are thus not terminals on the duplex-capable network.

The one or more cameras are thus triggered in an event-controlled manner. For example, the trigger signal can be triggered by a photoelectric barrier when, as an event, the light beam is interrupted by an object to be captured. The trigger signal is input to the external trigger input of the synchronization module, whereupon the synchronization module transmits a trigger telegram via the first logical channel. The trigger telegram then triggers the image capture in one or more cameras connected to the network.

It is especially favorable with respect to no-delay or at least small-delay control of the cameras when the synchronization module and camera have two logical channels that have different priorities for each data direction.

A first of the two logical channels has a first priority for synchronization signals and a second channel of the two logical channels has a second priority for the transmission of image data. The channel with the first priority can thus ensure the immediate information transmission at any time, especially such that a transmission of the second channel with the second priority can be interrupted without delay, so that the first channel has a real-time capability. In contrast, the second channel is advantageously provided with high data rates corresponding to the possibilities of the channel capacity of the physical medium and can be interrupted at any time for a sync-information transmission with the first priority, so that this channel does not have a real-time capability.

In particular, for more complex network architectures, it can be advantageous if the synchronization modules are equipped with a memory in which one or more propagation times or delays between different synchronization modules of the system and/or their variance are stored, and with the knowledge of these propagation times, a delay for the image capture is calculated or transmitted by means of a computational device. If the propagation times to different cameras are different, then this can be taken into account by the cameras for the image capture and/or by a synchronization module for the transmission time of an image-capture signal or a trigger telegram via the network.

In a refinement of this embodiment of the invention, a delay matrix can be formed from the measured, typical delay times of point-to-point connections, wherein this matrix describes the delay between arbitrary trigger sources and cameras, so that, after the appearance of a trigger signal, the delay that guarantees optimal jitter or the smallest possible time differences for the captures by the cameras can be selected.

Furthermore, the synchronization modules can also be equipped partially or completely with real-time clocks or counters that provide the/a heartbeat of the host under consideration of the delay between the host and the synchronization module. The opportunity presents itself to transmit, in the trigger signal, the measured clock time or equivalent data representing the time of the transmitting synchronization module. The time signal can then be evaluated in the receiver, for example, through the addition of an offset. The capture is then triggered only after the calculated time offset.

For example, the delay can also be calculated in a simple way with reference to half of the average time difference between the transmission and the reception of an acknowledgment, especially for critical networks with high, unstable delay times, by averaging over several such events.

Especially for more complex network architectures, it is further favorable if real-time-critical camera control signals or trigger signals are transmitted via the network not to the camera, but instead indirectly to the synchronization module as a trigger device and filtered there according to priority and then forwarded to a camera or a select group of cameras.

According to another refinement of the invention, one or more cameras could be designed in order to transmit the readiness for a new image capture or the end of the image data transmission to a synchronization module via the network, advantageously as a real-time-critical control signal. Referring to this signal, the synchronization module can recognize that a delay-free image capture is now possible, without having to interrupt the transmission of image data by the camera. This embodiment of the invention is especially favorable when simultaneous image capture is the priority and the absolute time of the image capture is less of a priority.

Furthermore, it can be favorable if the synchronization module is formed to transmit to a camera a signal for interrupting an image transmission and/or another signal for repeating the transmission of a part of an interrupted image from the image memory of this camera. A separate signal for interrupting the image transmission can then be transmitted shortly before the transmission of a trigger signal or an image-capture signal via the first logical channel. This reduces the network traffic during the transmission of the image-capture signal, and thus also the risk of data loss.

### BRIEF DESCRIPTION OF THE DRAWINGS

The invention will be explained in greater detail below using embodiments and with reference to the accompanying drawings. Here, the same reference numerals in different figures refer to the same or corresponding elements.

Shown are:

FIG. 1, a schematic of a first embodiment of a networked camera system,

FIG. 2, the flow of a trigger sequence,

FIG. 3, the flow of a real-time acknowledgment sequence,

FIG. 4, an embodiment of a system in which the synchronization modules are equipped with memories,

FIG. 5, an embodiment in which the delay times and the jitter between the network components are taken into account for the image-capture time,

FIG. 6, a schematic diagram of the synchronization of real-time clocks, and

FIG. 7, the principle of the control data rerouting with reference to elements of the networked camera system.

### DETAILED DESCRIPTION

### Embodiment 1

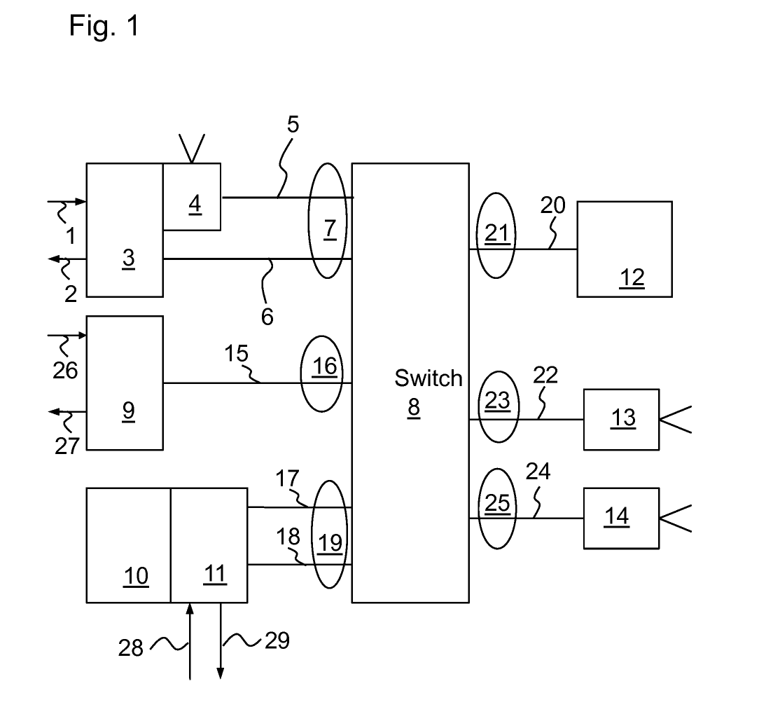

FIG. 1 shows, as an example, a typical realization of a camera network. Below, designations that are typical for Ethernet have been selected. However, it is clear to someone skilled in the art that the embodiment can be applied accordingly to other duplex-capable networks (IEEE1394, etc.).

### Switches and Hubs

An Ethernet hub is a non-intelligent multiport repeater for connecting Ethernet devices. Hubs are very fast since the packets are neither stored nor relayed. With a hub, one speaks of a “shared” Ethernet, i.e., exactly one device can transmit at a single point in time; all of the other devices must wait during this time. The propagation times are no longer predictable, even for networks with low loads. For this reason, hubs are not preferred for networking the network components to each other.

Therefore, at the least, switching hubs (switches) are preferred. A switch examines each Ethernet frame with respect to its embedded target address and selectively relays the frame to the corresponding port. Therefore, the network load drops and collisions are avoided (in full-duplex mode). In this way, the full bandwidth of the switch is made available to each channel and network devices no longer have to wait. A delay in the signal relay is indeed generated by the switch, but this additional delay caused by the switching logic is generally constant and therefore can be calculated.

### Network Architectures

In principle, it is possible to arbitrarily cascade switches. Here, however, it should be taken into account that the store & forward function of the switch delays the relay. These switch dwell times add up and represent the limiting characteristic of a network topology as a function of the requirements of the specific application.

If so-called managed switches are used and these switches use RSTP or STP management protocols, arbitrary network topologies could be realized. (RSTP: Rapid Spanning Tree Protocol)

The synchronization message is transmitted by the SYNC module as a TCP/IP-conforming packet. This packet can be transmitted here as a unicast, multicast, or broadcast packet. The optimum jitter is guaranteed by the priority control of the SYNC module and by time synchronization based on IEEE1588.

### SYNC Module Priority Control

Priority control is based on the fact that the entire data stream moving in the direction toward the camera is relayed via the SYNC module. Here, synchronization modules with the highest priority are handled in hardware. All other control data is handled at a lower priority.

Technologies, such as VLANs, QoS, or priority queues can also be used, but are not absolutely necessary.

FIG. 1 shows a schematic of a first embodiment of a networked camera system. In FIG. 1, each of the reference numerals 1, 26, 28 refers to a trigger input; each of the reference numerals 2, 27, and 29 refers to a signal or trigger output; each of the reference numerals 3, 9, and 11 refers to a synchronization module; each of the reference numerals 4, 13, and 14 refers to a camera unit; each of the reference numerals 5, 20, and 24 refers to a logical channel with high data rate; each of the reference numerals 6, 15, and 18 refers to a logical channel with high-priority or real-time capability; each of the reference numerals 7, 16, 19, 21, 23, 25 refers to a physical Ethernet connection, for example, an Ethernet network cable; reference numeral 8 refers to a switch; and reference numeral 10 refers to a computer for processing the image data, for example, a PC.

In FIG. 1, three different embodiments of synchronization units are shown:

The synchronization module 3 is connected to the camera 4 or integrated into the camera 4.

The synchronization module 3 can be realized, for example, with hardware structures present in the camera. A signal on the existing trigger input 1 triggers the transmission of the trigger command to the network. Because there is still no image transmission immediately after a trigger signal, for a common use of the interface for the trigger and image data transport, no additional delay occurs. In addition to the trigger input 1, the synchronization module 3 also has a trigger output, by which means a switching signal can be transmitted to an external device connected, in particular, to the network. For example, a flash unit that generates a flash for lighting during the image capture could be connected to the trigger output 2.

In contrast, the synchronization module 9 is constructed as an external device:

In this embodiment, the device has one or more trigger inputs and/or outputs. Due to its mechanical and electrical interface, it can be optimally integrated into the image processing system. In the example shown in FIG. 1, the synchronization module has a trigger input 26 and a trigger output 27 for signals from and to external elements, respectively. For example, an electrical signal can be triggered by a photoelectric barrier or another sensor and given to the trigger input 26. The trigger output 27 can be used like the trigger output 2, for example, for connecting a flash unit.

Finally, the synchronization module 11 with the trigger input 28 and trigger output 29 is formed as a component or module of a PC/embedded system 10.

For integration in a computer system, the synchronization module 11 is mapped to the outside advantageously as a stand-alone external device. If several network interfaces are present, no switch 8 is required.

By means of a network architecture as shown in FIG. 1, the image capture of the cameras 4, 13, 14 can be synchronized in that one of the synchronization modules 3, 9, 11 transmits an image-capture signal via the correspondingly assigned logical channel 6, 15, 18 with high priority. When it is received, the image-capture signal or image-capture telegram transmitted via the network triggers image capture by the cameras. The image data is then transmitted by the image-capture devices or camera units 4, 13, 14 via the correspondingly assigned logical channel of high data rate, that is, one of the channels 5, 22, 24, via the network and can then be further processed by the computer 10.

In general, without restriction to the example shown in FIG. 1, each of the logical channels can have a different IP address.

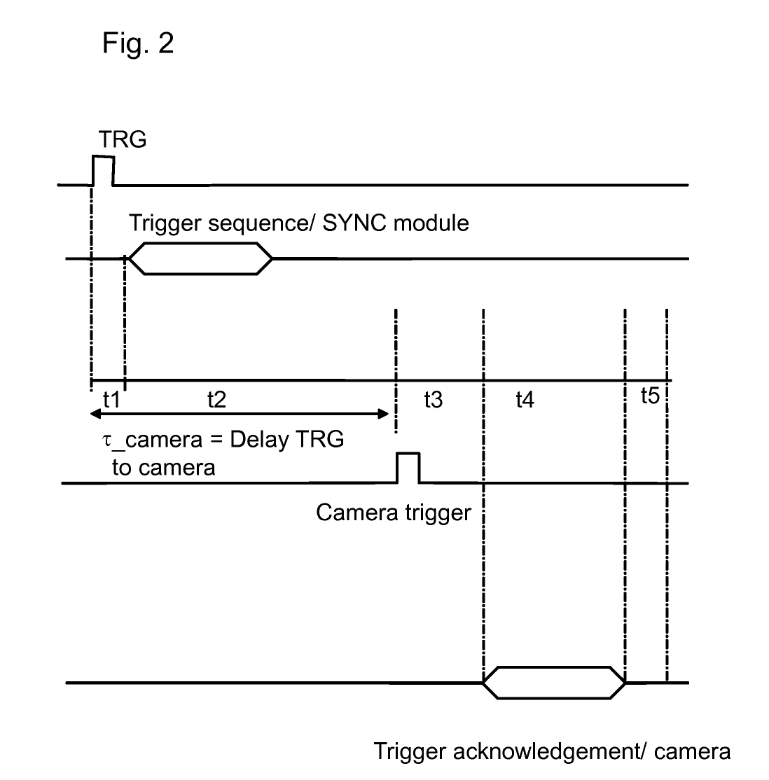

FIG. 2 shows the flow of a trigger sequence. After a trigger appears, a time t1 elapses until the trigger command is transmitted. The packet propagation time equals t2. After triggering an image, after the delay t3, an acknowledgment is transmitted from each triggered camera to the corresponding synchronization module. The acknowledge telegram contains a status code that is used for error and exception handling. For handling synchronization telegrams that have been lost, an AcknowledgeTimeout of the sender is used. After the return time t4, this appears in the synchronization module. t5 is the minimum time until another trigger can be accepted.

The packet propagation time can be determined from the time difference τ=t1+t2+t3+t4+t5 between the transmission of the command and the reception of the acknowledgment. In particular, the packet propagation time τ_camera can be set approximately equal to τ/2. The jitter can be calculated from the standard deviation of the propagation times.

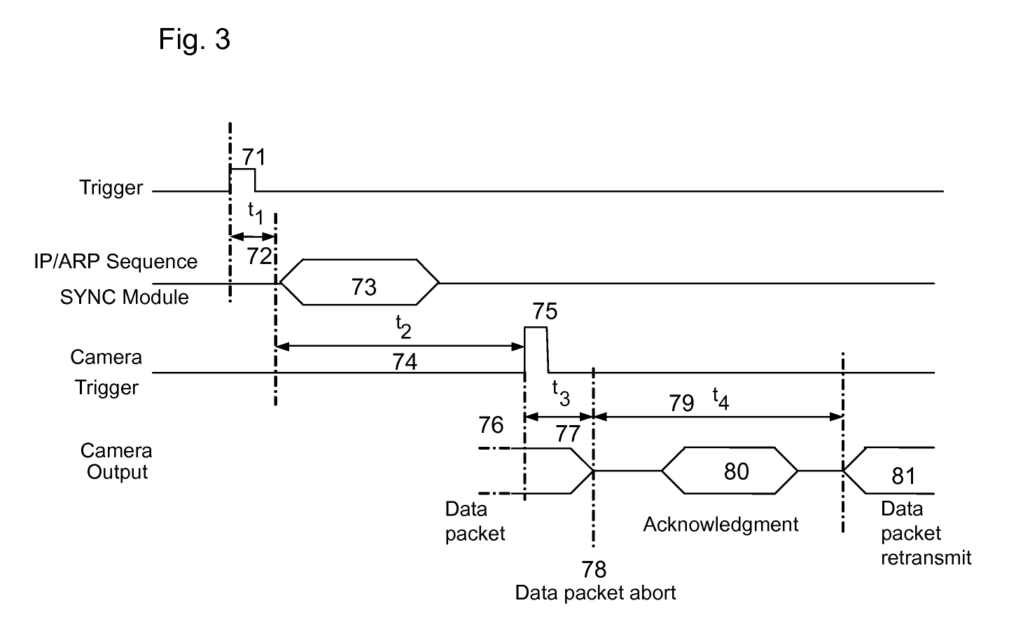

The flow of a real-time acknowledgment sequence is shown in FIG. 3. In FIG. 3, the reference numeral 71 refers to the hardware trigger signal; 72 refers to the delay between the trigger signal and the start of the sequence, for example, an IP/ARP sequence; 73 refers to the period of the sequence for transmitting an image-capture telegram; 74 refers to the delay between the start of the sequence from the synchronization module to the camera unit and the detection of the trigger command; 75 refers to the internal camera trigger signal; 76 refers to a streaming packet of high data rate; 77 refers to the delay between the internal camera trigger signal 75 and the time point 78 that the transmission of the data packet 76 is interrupted; 79 refers to a time window for the real-time transmission of the acknowledgment of the trigger telegram; 80 refers to the period of the sequence transmitted from the camera to the synchronization module for the acknowledgment of the image-capture telegram (for example, also in the form of an IP/ARP sequence); and 81 refers to the retransmitted data packet with the data corresponding to the data packet 76. For transmitting the acknowledgment signal 80, a time window 79 is used during which the channel is not occupied by other logical connections. This can be guaranteed if a data transmission 76 taking place at the time of the trigger detection 75 is interrupted (time point 78). The acknowledgment signals of the triggered cameras can be transmitted offset in time t 4 (time window 79).

### Embodiment 2

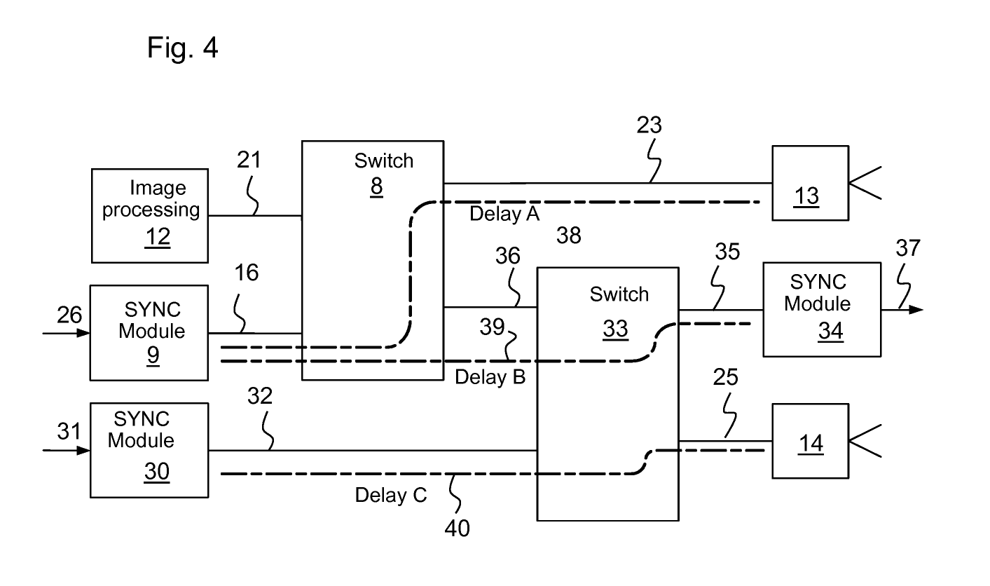

FIG. 4 shows a system in which synchronization modules are used with memories that store the propagation times between different synchronization modules (38 . . . 40). With the knowledge of these propagation times, path-dependent delay information can be transmitted along with the trigger command.

In FIG. 4, the reference numeral 8 refers to a switch; each of 9, 30, and 34 refers to a synchronization module formed, in particular, as a stand-alone unit; 12 refers to an image-processing device, for example, a PC; 13 and 14 each refer to a camera unit formed as a stand-alone unit; 16, 21, 23, 25, 32, 35, and 36 refer to physical Ethernet connections or Ethernet network cables; 26 and 31 refer to trigger inputs; 37 refers to a signal output, for example, for triggering a flash; 38 refers to a delay A; 39 refers to a delay B; and 40 refers to a delay C. In the sense of the invention, a stand-alone unit is understood to be a unit that is directly coupled to the network.

### Embodiment 3

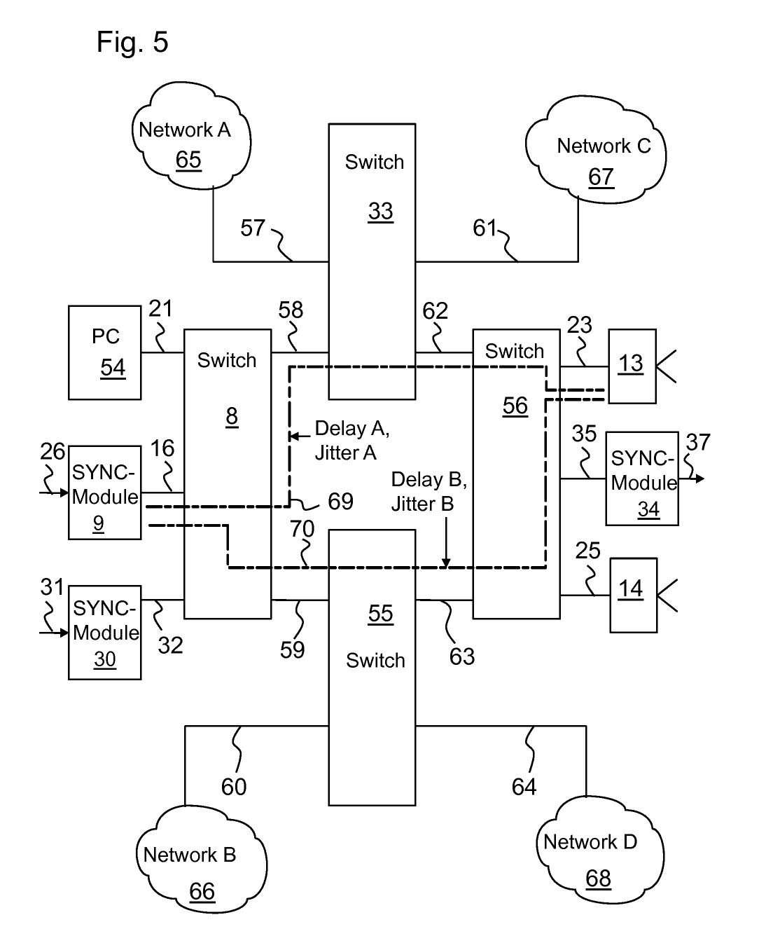

In FIG. 5, the reference numeral 54 refers to an image-processing device, for example, a PC; 55 and 56 each refer to a switch; 57, 58, 59, 60, 61, 62, 63, 64 refer to physical Ethernet connections or Ethernet network cables; 65, 66, 67, and 68 refer to networks connected to the switches 33 or 35; 69 refers to a logical path with a delay A and a jitter A; and 70 refers to a logical path with a delay B and a jitter B.

In FIG. 5, a network is shown in which the delay times and the jitter between the network components are known (e.g., delay and jitter between switch (8) and switch (33)) and are stored in matrix form in the synchronization modules 9, 30, 34. The corresponding times for an end-to-end connection (e.g., path (69) composed of the sections (9.8), (8.33), (33.65), (56.13)) can be calculated from the sum of the times of the sections. If two paths are possible for an end-to-end connection, the path that is best-suited for the application can be selected with reference to the matrix.

### Embodiment 4

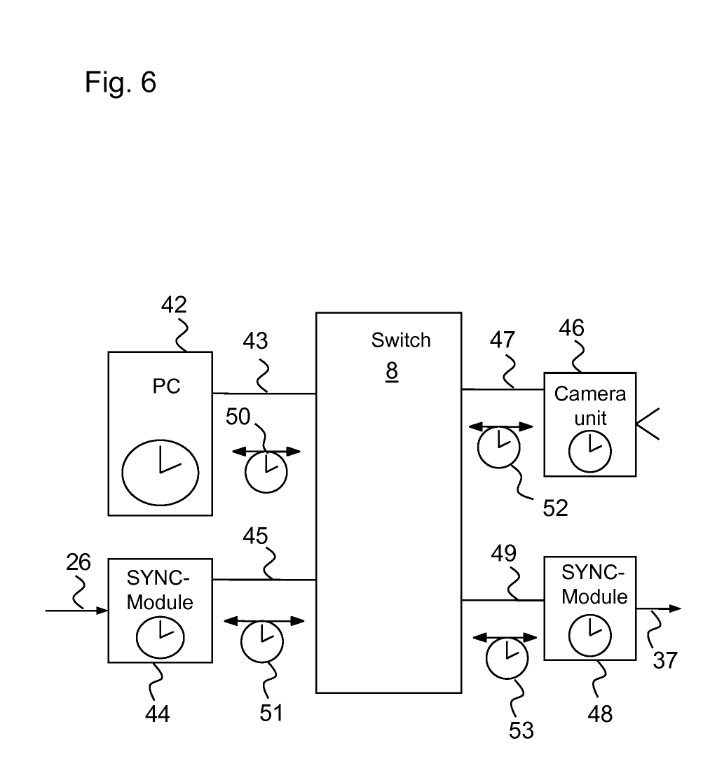

Reference is made to FIG. 6. In FIG. 6, the reference numeral 8 refers to a switch; 26 refers to a trigger input; 37 refers to a trigger output; 43, 45, 47, and 49 refer to physical Ethernet connections or Ethernet network cables; 44 and 48 refer to synchronization modules advantageously formed as stand-alone units; 46 refers to a camera unit advantageously formed as a stand-alone unit. Each of the clock symbols 50, 51, 52, 53 represents an exchange or an update of the system time. This exchange will be described below.

The synchronization of the real-time clocks of all of the subscribers is performed according to the IEEE1588 standard, also called “Precision Clock Synchronization Protocol for Networked Measurement and Control Systems” or “PTP.”

In this way, a master clock transmits a first “SYNC” telegram. This telegram contains the estimated transmission time. In a second “follow up” telegram, the exact transmission time is sent. On the receiver side, the time difference between two clocks can then be calculated by means of its own clock. In another transmission process, the telegram propagation time will be calculated. With this delay time, the receiver is in the position to correct its clock accordingly and to adjust the actual bus propagation time.

The master clock or its time can be provided, for example, by the PC 42. Accordingly, in the example shown in FIG. 6, at first the times of the camera unit 46 and the PC 42 are synchronized; the switch 8 has a constant delay. After exchange 50 and 52 that is performed as described above, additional exchanges 50 and 51, as well as 50 and 53 starting from PC 41 with the synchronization modules 44, 48 are performed.

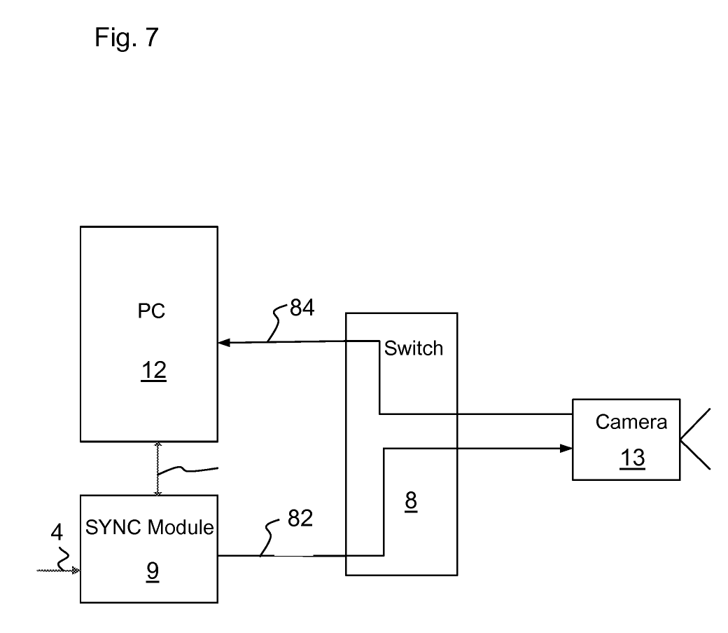

In FIG. 7, the principle of the control data rerouting is shown. The PC 12 transmits GigE control commands, among these heartbeat commands, to the synchronization module 9 via the connection 83. The SYNC module synchronizes the control data and the trigger commands and forwards these via channel 82 to the camera 13. The camera 13 transmits the image data, not in real time, via channel 84 to the PC 12.

1. Method for synchronizing camera systems via a duplex-capable network in which, within the network, one or more hardware-supported synchronization modules with a logical channel of a first type are used, the method comprising:
receiving image-capture signals at image-capture devices from the one or more synchronization modules via the logical channel of the first type, wherein the image-capture signals control the capture time of image sensors at the image-capture devices;
capturing an image at each of the image-capture devices in response to the reception of an image-capture signal, resulting in image data; and
transmitting the image data via the network, from the image-capture devices via a logical channel of a second tyDe.

2. Method according to claim 1 characterized in that external switching signals are each received or transmitted by means of one or more outputs of a synchronization module.

3. Method according to claim 1 characterized in that a trigger signal is given to a trigger input of a synchronization module, whereupon the synchronization module transmits, as a response to this trigger signal, at least one image-capture signal via the network.

4. Method according to claim 1 characterized in that the one or more synchronization modules and the image-capture devices have two logical channels that have different priorities for each data direction.

5. Method according to claim 4 characterized in that a first of the two logical channels has a first priority for synchronization signals and a second channel of the two logical channels has a second priority for the transmission of image data, wherein the channel with the first priority ensures the immediate transmission of information at any time and, for this purpose, a transmission of the second channel with the second priority can be interrupted with no delay, so that the first channel has a real-time capability, and wherein the second channel provides high data rates corresponding to the possibilities of the channel capacity of the physical medium.

6. Method according to claim 1 characterized in that the synchronization modules are equipped with a memory in which one or more propagation times or delays between different synchronization modules of the system and/or their variance are stored and in that, with the knowledge of these propagation times, a delay for the image capture is calculated or transmitted by means of a computational device.

7. Method according to the claim 6 characterized in that a delay matrix that describes the delay between arbitrary trigger sources and the image-capture devices is formed from the measured typical delay times of point-to-point connections, so that, after the appearance of a trigger signal, the delay that ensures optimum jitter can be selected.

8. Method according to claim 1 characterized in that the one or more synchronization modules are partially or completely equipped with real-time clocks or counters that are set via the heartbeat of the host, taking into account the delay between the host and a synchronization module, and in that the measured clock time of the transmitting synchronization module is transmitted in the trigger signal and evaluated in the receiver.

9. Method according to claim 1 characterized in that real-time-critical camera control signals are transmitted not to the image-capture device but instead indirectly to a synchronization module as a trigger device and filtered there according to priority and relayed to an image-capture device or a select group of image-capture devices.

10. Method according to claim 1 characterized in that the image-capture device transmits the readiness for a new image capture or the end of the image data transmission as a real-time-critical control signal to a synchronization module via the network.

11. Method according to claim 1 characterized in that a synchronization module transmits a signal for interrupting an image transmission and/or another signal for the repeated transmission of a part of an interrupted image from the image memory of an image-capture device.

12. Networked camera system with image-capture devices, the system comprising:
a duplex-capable network; and
one or more hardware-supported synchronization modules with a logical channel of a first type connected to the duplex-capable network, wherein the one or more synchronization modules are designed to transmit image-capture signals via the logical channel of the first type, wherein these image-capture signals control the capture time of image sensors of the image-capture devices and the image-capture signals are received by the image-capture devices, and wherein the image-capture devices capture an image in response to the reception of an image-capture signal, and wherein the image-capture devices are designed to then transmit captured image data via a logical channel of a second type via the network.

13. Camera system according to claim 12 characterized in that the one or more synchronization modules have outputs for transmitting or receiving external switching signals.

14. Camera system according to claim 12 characterized in that a synchronization module is designed to transmit, in response to a received trigger signal, at least one image-capture signal via the network.
